(19) United States
(12) Patent Application Publication
(10) Pub. No.: US 2018/0362842 A1
(43) Pub. Date: Dec. 20, 2018

(54) HEAVY OIL WETTABILITY IMPROVER

(71) Applicant: Oil & Gas Tech Enterprises C.V., Noordwijk (NL)

(72) Inventor: Cridal Del Valle Sencial Bello, El Tigre (VE)

(21) Appl. No.: 16/010,178

(22) Filed: Jun. 15, 2018

Related U.S. Application Data
(60) Provisional application No. 62/521,131, filed on Jun. 16, 2017.

(51) Int. Cl. C09K 8/86; C09K 8/60; E21B 43/16; E21B 49/08; E21B 49/00; G01V 99/00

(52) U.S. Cl. CPC C09K 8/86; C09K 8/602; E21B 43/16; E21B 47/06; E21B 49/00; G01V 99/005; E21B 49/08

(57) ABSTRACT

The present disclosure is related to a basic chemical formulation to modify the wettability of a well formation, promoting a water-wet behavior in order to increase the medium, heavy or extra-heavy crude oil production, a method to determine the right components concentration and proportions of the chemical formulation to modify the wettability in any specific type of formation-crude oil combination and a method to use the optimized chemical formulation for the treatment of a determined well.

### CROSS-REFERENCE TO RELATED APPLICATIONS

This application claims the benefit of U.S. Provisional Application No. 62/521,131 filed on Jun. 16, 2017, which is incorporated by reference in its entirety.

### TECHNICAL FIELD

The present disclosure relates to compositions, methods, and systems for crude oil extraction.

### BACKGROUND

In current oilfield technology, there are several methods used in medium, heavy and extra heavy crude extraction during production, secondary and tertiary recovery processes, to minimize the energy required to pump the crude up to the surface.

Among such methods, some relate to the modification of the crude properties like viscosity. Other methods modify the interaction between the oil/gas and the formation. Still other methods deal with different pumping technologies. Such methods aim to maximize the “oil production rate vs. energy consumed” ratio, with the main limiting factors being the equipment and material costs together with the energy demands.

Among the known methods used to modify the interaction between the oil/gas and the formation are the so-called “flooding” methods, which comprise the injection of surfactant containing chemicals in order to increase the amount of oil extracted from the formation without increasing the supplied pumping energy. The main role of the injected surfactant is to modify the wettability of the formation rocks or sands, turning the hydrophobic behavior into a hydrophilic behavior; thus, the oil-wet behavior of the rock, or sand of the formation or bituminous sands, changes into a water-wet behavior.

Commercial surfactants currently used in medium, heavy and extra heavy crude oil wells perform differently in different wells. Some surfactants are better suited for certain crude and/or formation characteristics, and consequently, effective for those wells, while showing only a marginal oil recovery improvement in other wells, which may even elevate the overall production cost of those wells without a net benefit.

The “Faja Petrolifera del Orinoco” (Orinoco Belt) is an oil producing region located in south western Venezuela, and one of the largest reservoirs of medium, heavy and extra heavy crude oils on Earth. Production of medium (API gravity from 22 to 30), heavy (API gravity from 12 to about 22) and extra heavy (API gravity from 7 to about 12) crude oil entails elevated costs and exhibit additional complexity due to a high variability in mechanical and physical properties of both oil and formation, even in geographically nearby wells. Due to this variability, the same methods are not equally effective in different wells within the same field, decreasing the efficiency of those methods and, in certain instances, even making them useless. The crude oils of the Orinoco Belt are Junin (API 10), Boyacá (API 10.5), Ayacucho (API 16), and Carabobo (API 4 to 16), named after the fields where they are found and produced. Even within crudes of the same field, significant behavioral differences regarding crude and formation characteristics and behavior towards production strategies can be found.

The friction of medium, heavy and extra heavy crude oils from “La Faja del Orinoco” with the pipeline walls can be successfully reduced through the addition of a specially formulated surfactant mixture described by U.S. Pat. No. 9,587,199 B2, the entirety of which is incorporated herein by reference, that promotes the formation of a multiphase mixture and simultaneously turns the pipeline's inner walls into hydrophilic surfaces.

Formation wettability is one of the physical properties of an oil formation that can lead to an abrupt decrease of a well production once the natural pressure of the reservoir decays as the reservoir depletes, and when it exhibits an oil-wet tendency added to a low porosity and permeability. This may cause the early abandonment of the well when Enhanced Oil Recovery (EOR) methods prove inefficient or useless. Improper EOR operations, like the application of polymer based stimulation fluids, can lead to severe reservoir damage, including permeability and wettability changes that turn the formation into oil-wet and thereby inhibit the flow of crude to the well. The crude oil flow from the reservoir into the well hole depends on several factors such as permeability, viscosity and temperature of the fluid, and the confining pressure of the fluid, in addition to the wettability properties of the formation.

The measurement of the damage caused by a fluid that was injected into the reservoir can be carried out by a Permeability Restoration Test, which comprises a forced flow of a typical oil of the formation through a mineral core sample before and after implicating the stimulation fluid.

Current experimental surface wettability measurements in oil field applications involve qualitative methods like the floatation method and the relative permeability method, and quantitative methods, which include the Contact Angle measurement, the Amott Method, and the USBM method. Each of the wettability measurement techniques has relative advantages and disadvantages, depending on the surface type of the application and the required response time, cost, accuracy and precision.

### SUMMARY

The present disclosure provides a stable, homogeneous, low-cost, easy-to-adapt chemical formulation for wettability modification, a procedure to inject the formulation into an oil well, and a method to determine the required proportions of the formulation's constituent components to best suit each particular well characteristics and conditions, as well as the crude oil properties, in order to reduce the overall production costs of medium, heavy and extra heavy oil wells with different characteristics.

Friction reduction observed in pipelines of different medium, heavy and extra heavy oil from “La Faja del Orinoco” (Orinoco Belt) after addition of a mixture described by U.S. Pat. No. 9,587,199 B2 provides evidence of the influence of particular chemical components and their relative concentrations in a multiphase mixture that can be used to turn the oil-wet behavior of formation rocks, sands or bituminous sands into water-wet behavior.

In some embodiments, the present disclosure provides a formulation for wettability modification which can be injected into medium, heavy or extra-heavy crude oil/gas wells during regular production or as an Enhanced Oil Recovery method during secondary or tertiary recovery procedures, which can produce a change from oil-wet tendency into a mixed or a water-wet tendency in order to increase the oil production/energy consumption ratio of the well, and allow profitable operations in wells with very poor to negligible recovery rates due to reduced formation permeability and natural pressure drop.

In some embodiments, the present disclosure provides a basic chemical formulation for wettability modification of medium, heavy and extra heavy oil wells which can produce similar positive oil recovery results in oil/gas wells with different specific mineral characteristics of the formation or bituminous sands, bearing different medium, heavy and extra heavy oil types and characteristics, and different reservoir conditions, by the variation in the relative concentration of the chemical components of the basic chemical formulation while remaining as a stable mixture, allowing the use of the chemical formulation among a large number of oil fields and wells which simplifies procedures and reduces operating costs.

In some embodiments, the present disclosure provides a chemical formulation for wettability modification that is non-harmful to a formation's original permeability.

In some embodiments, the present disclosure provides a chemical formulation for wettability modification that contributes to the restoration of the original wettability tendency of a formation, distorted by former treatment with harmful stimulation fluids.

In some embodiments, the present disclosure provides a chemical formulation for wettability modification that may be obtained from mixing low cost commercial chemical components by standard procedures, resulting in a lower cost option than commonly used oilfield stimulation fluids.

In some embodiments, the chemical formulation for wettability modification disclosed herein reduces the friction of a multiphase fluid comprising the chemical formulation, medium, heavy or extra-heavy oil, some formation water and, if present, natural gas, and also reduces the necessary pumping energy to move the fluid, without creating an emulsion or modifying the viscosity of the oil.

In some embodiments, the present disclosure provides a method to obtain the most suitable approximate relative concentration of each component of the chemical formulation according to the well, formation and oil characteristics, in order to achieve the best performance in wettability modulation of the formation rocks and sands.

In some embodiments, the present disclosure provides a method for oil/gas well stimulation by modifying the wettability of the rock or sands in an oil bearing formation, which may include treating the well with a stimulation fluid derived from a basic chemical formulation.

In some embodiments, a chemical formulation, which is based on brine but not on polyolefins, polyacrylamides, or polyacrylates, is mixed with water-soluble surfactants as active components, the salt of a weak acid as a pH regulator, and non-aromatic solvents. Such a formulation may exhibit a satisfactory friction reduction, permeability enhancement and capability to modulate wettability from oil-wet to water-wet, achieved for medium, heavy and extra-heavy oil, in producing oil wells, as well as in multiphase fluid conduits.

One potential benefit that may be realized is that the proportions of the components of the chemical formulation for well stimulation can be adjusted to best suit the formation/oil characteristics combination by utilizing a method that considers historical well data and laboratory test results.

Savings in the consumption of pumping energy, and a real possibility to increase the oil production rate, especially for medium, heavy and extra-heavy oil, may be realized according to certain embodiments disclosed herein.

Friction reduction, permeability enhancement and wettability changes to, preferentially, water-wet, without formation damage, are achieved through changes in the physical-chemical interaction between the fluid and the rock, allowing the crude oil to flow with relatively less applied energy and without major viscosity changes.

In addition to reducing crude oil friction, the disclosed chemical formulation may restore damage or permeability and wettability changes in a formation that may have occurred during the well construction and production stages.

The hydrophilic groups on the head of the surfactant molecules allow creation of a thin film of water on the rock and/or inner conduit surfaces that result in an enhanced crude oil mobility due to the sliding of the crude over the surfaces. The hydrophobic chains (or tails) keep the crude moisture away from the water-wetted surfaces.

### BRIEF DESCRIPTION OF THE DRAWINGS

The above and further advantages of the exemplary embodiments may be better understood by referring to the following description in conjunction with the accompanying drawings, in which same numbers indicate similar structural elements and features in various figures. The drawings are not necessarily to scale; instead the emphasis is placed on illustrating the features of the exemplary embodiments.

FIG. 1 is a graph illustrating a Bingham plastic behavior of Example 1 according to an exemplary embodiment of the present disclosure;

FIG. 2 is a graph illustrating viscosity of Example 1 according to an exemplary embodiment of the present disclosure;

FIG. 3 is a graph illustrating a Pseudo-plastic behavior of Example 2 according to an exemplary embodiment of the present disclosure;

FIG. 4 is a graph illustrating viscosity of Example 2 according to an exemplary embodiment of the present disclosure;

FIG. 5 illustrates a number of comparative samples demonstrating wettability of Example 3 according to an exemplary embodiment of the present disclosure;

FIG. 6. is a schematic view of an exemplary embodiment of a system and method provided according to the present disclosure;

FIG. 7 is a schematic view of another exemplary embodiment of a system and method provided according to the present disclosure;

FIG. 8 is a schematic view of yet another exemplary embodiment of a system and method provided according to the present disclosure; and

FIG. 9 is a schematic view of an exemplary embodiment of a hardware configuration for performing methods according to the present disclosure.

### DETAILED DESCRIPTION

Exemplary embodiments of the present disclosure relate to a chemical formulation that may be used as a wettability improver in medium, heavy and extra heavy oil wells, resulting in a change of the wettability of the formation rocks and sands from oil-wet into water-wet tendency, which may improve the oil recovery performance of the well. In some embodiments, the proportions of the chemical components of the chemical formulation are adjusted according to characteristics of the well.

This disclosure relates to a brine based chemical formulation that is not based on polyolefins, polyacrylamides, or polyacrylates, for which reason it is less harmful to the formation.

By including a water soluble surfactant as active component in a brine and a non-aromatic solvent as part of the chemical formulation, chemical formulations disclosed herein exhibit satisfactory friction reduction, permeability enhancement and capability to change wettability from oil-wet to water-wet for medium, heavy and extra-heavy oil in producing oil wells, as well as in multiphasic fluid conduits. Some observed benefits include the increase of the production rate, especially for medium, heavy and extra-heavy oil, together with pumping energy consumption savings.

Exemplary embodiments of chemical formulations for wettability modification disclosed herein comprise a brine based mixture of non-aromatic solvents with low-toxicity, biodegradable components. The components include as active components, but are not limited to, a strong organic acid, a non-ionic surfactant and a pH adjuster.

The organic acid, that acts as surfactant precursor, may be utilized at a 0.1 to 10% weight concentration, preferably between 0.2 and 5% weight concentration, based on the weight of the final formulation. Suitable organic acids preferably have a pKa value between −2 and 2, and include, but are not limited to sulfonic acids, alkylsulphonic acids, arylsulfonic acids and/or mixtures thereof. Preferred organic acids are selected from the group consisting of formulas (1) and (2) below:

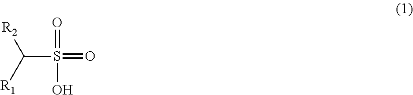

where:
R1 is an hydrogen atom and R2 is a linear or branched saturated, unsaturated or cyclic hydrocarbon substituent or R1 and R2 are both linear or branched, saturated, unsaturated or cyclic hydrocarbon substituents and R1 and R2 together have a total of 10 to 50 carbon atoms.

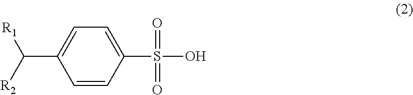

where:
R1 is an hydrogen atom and R2 is an alkyl substituent or R1 and R2 are both alkyl substituents, and R1 and R2 together have a total of 6 to 24 carbon atoms.

Some examples are linear dodecylsulfonic acid, 1-dodecenesulphonic acid, or petroleum sulfonic acid.

The non-ionic surfactant that acts as co-surfactant may be utilized at a 0.1 to 10% weight concentration, preferably between 0.5 and 5% weight concentration, based on the weight of the final formulation. Suitable non-ionic surfactants include, but are not limited to ethoxylated fatty alcohols, ethoxylated fatty acids, ethoxylated fatty acid esters, ethoxylated phenols and alkylphenols, polyethylene glycol ethers and/or mixture thereof. Preferred non-ionic surfactants are selected from the group consisting of formulas (3), (4), (5) and (6) below:

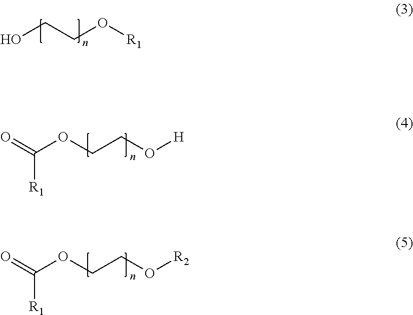

where:
R1 is a linear, branched or cyclic saturated or unsaturated hydrocarbon substituent with 4 to 20 carbon atoms, and R2 is an alkyl substituent with 1 to 10 carbon atoms.
n is an integer number representing the number of repeated ethoxy groups, with n between 2 and 70.

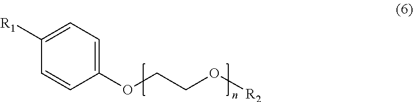

where:
R1 in a hydrogen atom or an linear or branched alkyl substituents with a total of 4 to 12 carbon atoms;
R2 is a hydrogen atom or n alkyl group with 1 to 4 carbon atoms.
n is an integer number representing the number of repeated ethoxy groups, with n between 4 and 70.

Some examples are Etholxylated nonylphenol (12) mole, Polyoxyethylene (20) oleyl ether, Poly(ethylene glycol) (12) tridecyl ether, Polyoxyethylene sorbitan monostearate (60) mole.

Exemplary pH adjusters include, but are not restricted to, weak bases, preferably selected from the group that comprises bases with pKb values between 6 and 10 and belong to the group of sodium or potassium carboxylates, carbonates, phosphonates and/or mixtures thereof. The base may be utilized in 0.1 to 10% weight, preferably between 0.2 and 5% weight concentration, based on the weight of the final formulation. The pH of the chemical formulation may be between 4 and 7. Suitable examples are sodium or potassium acetate and sodium or potassium citrates.

Table 1 describes an exemplary composition with corresponding weight percent ranges of the chemical formulation.

TABLE 1
Components of an exemplary composition

| Compound | Weight % |
|---|---|
| Sulphonic acid | 2-5 |
| Potassium acetate | 0.2-5 |
| Ethoxylated Nonylphenol (12) mole | 0.5-5 |
| Ethanol | 0.2-5 |
| Brine | 80-99 |

The abovementioned compounds are dissolved in a mixture of brine with a non-aromatic solvent selected from the group of low-molecular oxygenated compounds, preferably a low molecular alcohol such as ethanol or isopropanol. In some embodiments, the mixture comprises between 80 and 99% weight of the chemical formulation for wettability modification. The brine is a 1 to 10% weight solution of sodium or potassium chloride in water, where the water might be fresh water, formation water, or water from any other source, and/or a combination thereof.

The wettability modification may be achieved by direct injection of an aqueous solution of the chemical formulation for wettability modification downhole in crude oil wells were it penetrates the surrounding formation and impregnates the sands or rocks with the active ingredients. The dilution of the chemical formulation for wettability modification for its application depends upon the characteristics of each well. In some embodiments, a 10 to 30% weight of the formulation in water, formation water or brine is preferred.

The negligible effect of exemplary embodiments of the chemical formulation for wettability modification on the oil viscosity while reducing the friction of different heavy oil samples is demonstrated through laboratory viscosity Test 1 and Test 2.

Measurements on untreated and treated crude oils, performed with a Brookfield-CAP2000+L viscometer and the CapCalc 32 software, evidenced the friction reduction effect when the chemical formulation for wettability modification is used. The crude oils showed a Visco-Plastic or Pseudoplastic behavior.

Visco-Plastic fluid can be modeled by the Bingham Equation (Eq 1):

τ=τ₀+η\dot{y} (Eq 1)
τ: Shear Stress
τ₀: Yield Stress
η: Viscosity
\dot{y}: Shear rate (velocity)
   Pseudo-Plastic fluids can be modeled by the Power Law (Eq. 2):

τ=m\dot{y}ⁿ (Ec 2)
τ: Shear Stress;
m: flow consistency index;
n: flow behavior index
   Power-law fluids can be subdivided into three different types of fluids based on the value of their flow behavior index:
n<1: Pseudoplastic Fluid
n=1: Newtonian Fluid
n>1: Dilatant Fluid (less common)

### Example 1

### Test 1 (Friction Test on Extra Heavy Crude Oil Form Ayacucho Field)

Temperature: 25° C.
Rotational Speed: 50-400 RPM
Dose of chemical formulation: 1% V/V
Sample: PTO (extra-heavy crude oil diluted with naphtha from Ayacucho Field, 16 API)

The shear stress was measured in untreated (blank) and treated (1% V/V chemical formulation/crude oil) samples of the extra-heavy crude oil at different rotational speeds.

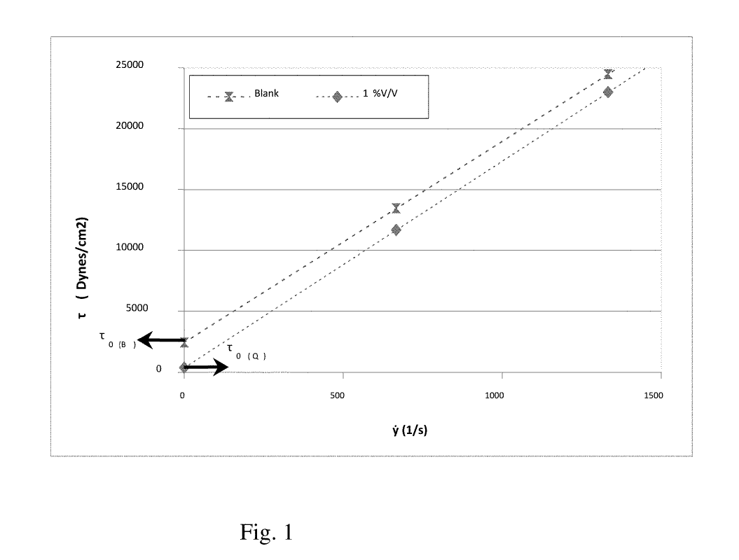

The Shear Stress (τ in Dynes/cm² units) vs Rotational Speed (Y in 1/s units) results from Test 1 (FIG. 1), show a Bingham plastic behavior for both treated and untreated samples. The reduction of the yield stress for the treated sample was 85%: from τ_{0(B)}=2435 Dynes/cm² for the “Blank” sample to τ_{0(Q)}=360 Dynes/cm² for the sample treated with the chemical formulation, which is interpreted as a reduction on the friction between the extra-heavy crude oil and a solid, making the flow less energy-consuming.

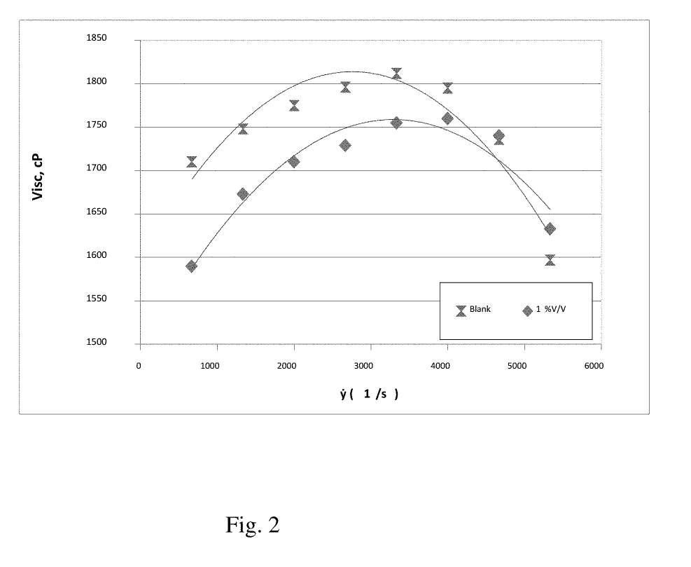

In FIG. 2, curves corresponding to both samples show similar slopes, which is interpreted as a negligible modification of the extra-heavy crude oil viscosity when the chemical formulation for wettability modification is applied.

FIG. 2 shows the viscosity for the “Blank” and the “1% V/V” samples in Test 1.

### Example 2

Test N.2 (Friction Test on Extra Heavy Crude Oil from Junin Field)
Temperature: 25° C.
Rotational Speed: 50-400 RPM
Dose of chemical formulation: 1% V/V
Sample: Junín Sur (extra-heavy crude oil from Junín Field, 10 API)

The shear stress was measured in untreated (blank) and treated (1% V/V chemical formulation/crude oil) samples of the extra-heavy crude oil at different rotational speeds.

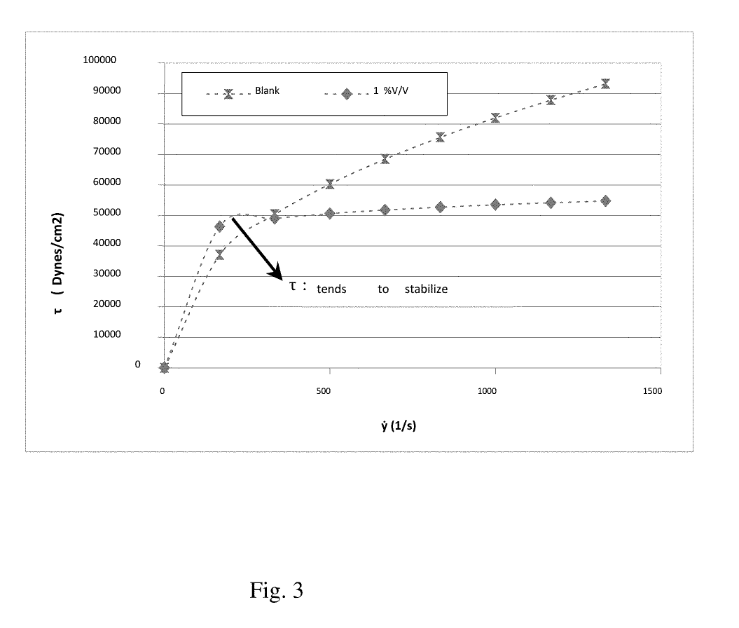

Results from Test 2 (FIG. 3), show a pseudo-plastic behavior for both treated and untreated samples. The reduction of the shear stress for the treated sample was 40%, which means that a certain shear stress is required to deform the fluid up to a specific level when the chemical formulation for wettability modification is applied, while the untreated crude oil requires a continuous shear rate increment for the same purpose.

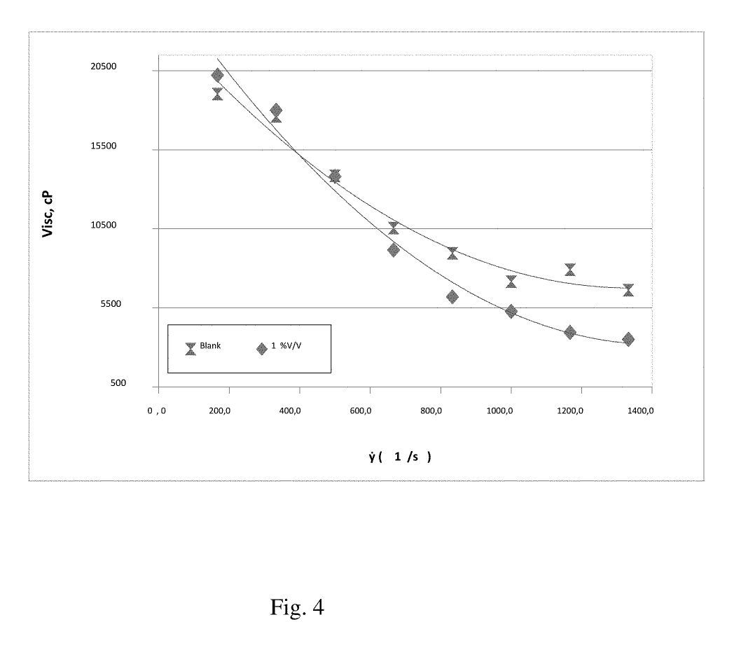

As for the Test 1 results, FIG. 4 shows that the viscosity does not change significantly when the chemical formulation for wettability modification is applied to the extra-heavy crude oil sample.

### Example 3

Exemplary embodiments provided in the present disclosure may improve the medium, heavy and extra-heavy crude oil flow from the reservoir to the well due to the wettability modification of the formation sands achieved through the effect of the surfactant on the mineral-crude oil interface.

Test 3 shows the changes in wettability of a sand surrogate (glass, silicate) in contact with a heavy crude oil treated with various commercial surfactant-based well stimulation fluids or wettability modifiers.

Test 3 (wettability changes of the heavy crude oil-glass interface)

A simple test was performed to evaluate changes in the crude oil-glass interface wettability due to the application of the herein disclosed chemical formulation for wettability modification and other commercial surfactants.

### Procedure:

Using an appropriate glass bottle, 1% V/V of the chemical formulation for wettability modification and other commercial surfactants was added to 50 ml of a heavy crude oil.
The bottle was thoroughly agitated and placed upside down and observed during the following 30 minutes.

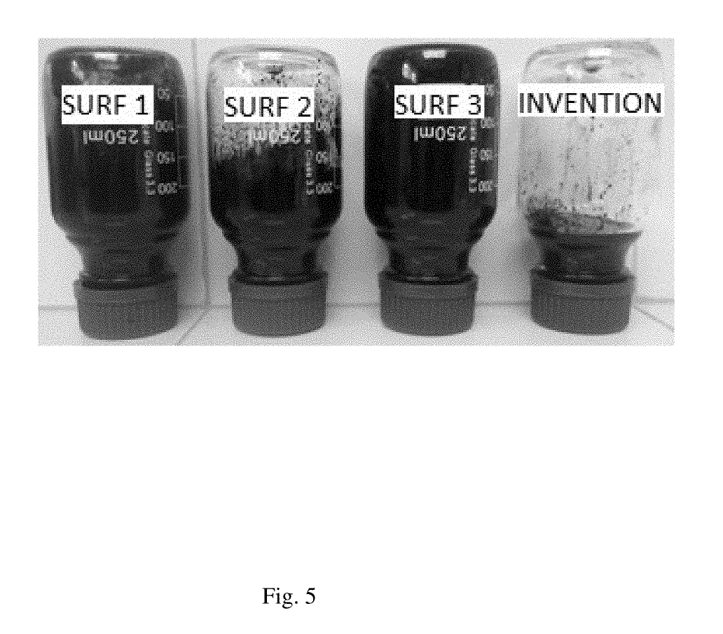

FIG. 5 shows the silicate (glass) bottles after 30 minutes, with “Surf 1”, “Surf 2” and “Surf 3” being the crude oil samples treated with the commercial surfactants and “Invention” the one treated with an exemplary embodiment of the chemical formulation disclosed herein. The most favorable change in wettability, that is, water-wet with no emulsion formation, was achieved by the exemplary embodiment of the chemical formulation.

Test 3 was repeated by inserting grained mineral into the bottles, resulting that cleaner grains were recovered from the samples treated with the chemical formulation of the present invention.

### Example 4

Test 4 was performed in order to assess the effect of an exemplary embodiment of a chemical formulation over the reservoir permeability and the formation wettability.

The chemical formulation for wettability modification was evaluated, including the application of the Amott test, in the Petroleum Laboratory of Zulia University's Technical Services Foundation, File: NUC-009-2016. The test was performed with three heavy crude oil samples (Petroboscan and two oils from the Orinoco Belt, namely, from the Petrocedeno and Petropiar oilfields) over Berea sandstone samples, before and after the addition of the chemical formulation.

The irreducible water saturation (S_{wi}) and the initial oil permeability (Kₒᵢ) were measured using samples saturated with a surrogate of each formation water at T=60° C. and P=600 psi during 24 hours.

The final oil permeability (K_{of}) was measured thereafter by sweeping the sample saturated with the chemical formulation.

The damage to the formation was estimated through the following equation 3 that relates the final permeability with the initial permeability:

Formation Damage=(K_{of}−Kₒᵢ)/(Kₒᵢ)*100 (Eq. 3)

The test results are displayed in Tables 2 and 3, showing the comparative wettability index and permeability results before and after the addition of the disclosed chemical formulation. The initial Berea sandstone samples with the heavy crude oils from Petrocedeno, Petropiar and Petroboscan oilfields were identified as “1A”, “2A” and “3A” while “1”, “2” and “3” were the same samples treated with the exemplary chemical formulation.

TABLE 2
Wettability Results

| | Oil | Wettability | Amott Index | Amott Index |
|---|---|---|---|---|
| Sample | Field | type | Water-Wetting | Oil-wetting |
| 1A | Petrocedeno | Oil-wet | 0 | 12.50 |
| 1 | Petrocedeno | Water-wet | 9.07 | 1.00 |
| 2A | Petropiar | Oil-wet | 0 | 19.34 |
| 2 | Petropiar | Water-wet | 10.81 | 0.00 |
| 3A | Petroboscan | Oil-wet | 0 | 32.71 |
| 3 | Petroboscan | Water-wet | 13.25 | 0.81 |

Table 2 shows a clear change from Oil-wet to Water-wet for the Berea samples impregnated with the three heavy oil tested when the chemical formulation was added.

TABLE 3
Permeability Results

| | Air | Koi. | Kof. | | |
|---|---|---|---|---|---|
| | Perme- | Inicial oil | Final oil | Retained | Formation |
| Sample | ability | permeability | permeability | Permeability | Damage |
| N. | [md] | [md] | [md] | [%] | [%] |
| 1 | 1380 | 17.45 | 94.02 | 539% | −439% |
| 2 | 1026 | 6.88 | 16.40 | 238% | −138% |
| 3 | 1038 | 16.40 | 36.45 | 222% | −122% |
| 1A | 1329 | 23.26 | | | |
| 2A | 1088 | 10.94 | | | |
| 3A | 1033 | 14.68 | | | |

Table 3 shows negative values for the “Formation Damage” assessment in samples treated with the exemplary chemical formulation, which means that the fluid does not react adversely with the formation fluids and minerals.

Other results show significant differences for porosities and permeabilities among crude oils-formation pairs. Further experiences demonstrated that by varying the proportions of the chemical formulation components, i.e. tuning the chemical formulation, it is possible to obtain better results.

Those results lead to the development of a method to obtain a specific chemical formulation for the different producing formations or bituminous sands, bearing a particular type of medium, heavy or extra-heavy weight crude oil. The method can include three sub methods and systems: (a) a “Well Characterization” subsystem, (b) a “Knowledge Database” subsystem, and (c) a “Processing” Subsystem.

In some exemplary embodiments disclosed herein, a method includes a first step comprising a “Well Characterization” process that allows putting together well data, such as formation and oil physical/chemical properties, residual pressure and reservoir temperature, which are obtained either by preceding existing data or by data obtained from lab tests. Such data, entered into an information system called a “Processing Subsystem”, is analyzed and compared with the data stored in the “Knowledge Database”, by mathematical and statistical procedures. The “Knowledge Database” is a database created from laboratory tests made with different crude oil and formation typical pairs to evaluate the right proportion of the components in the chemical formulation to achieve the desired wettability change in each case. Once the adjusted chemical formulation is used in the well stimulation process, the obtained results improve the “Knowledge Database” for other well stimulation processes.

The subsystems comprise at least one of the following steps:

### “Well Characterization”

a) Collection and parameterization of data from known well characteristics, comprising at least, the crude oil API gravity, chemical nature of the crude oil, crude oil maturity, geological formation of the reservoir, water/gas/oil proportions, production water composition, mineralogy of formation sands, depth of producing sands, temperature, natural pressure, permeability, porosity, historic flow rates, historical data on type of fluids used in preceding EOR procedures in the well (i.e. stimulation, recovery, artificial lift operations).
b) Laboratory evaluation and measurement of physical properties of at least one core sample of the formation, involving porosity, permeability, the so called well parameters.

### “Knowledge Database”

a) Laboratory wettability measurement through an experimental testing bench where at least one actual formation core sample or a synthetic sample with similar properties is tested, maintaining its physical integrity or being cut or crushed into smaller grains. The core is placed into a container filled partially, or totally, with crude oil from the well; the container includes mechanisms that allow pressure regulation and the addition of exemplary embodiments of the chemical formulation through single or multiple input sockets with flow rate and temperature regulation capabilities, where the fluids involved in the experiment (oil, water, chemical formulation solution) can be in contact with the core sample to wet it partially, imbibe it, or force it to pass through by simple gravitational acceleration, positive or negative pressure or induced forced movement or acceleration like rotation or centrifugation or the like, or linear movement like piston plunge displacements. Experimental procedure involves a statistical Design of Experiments (DOE) to establish the required wettability measurements that include the independent variables and levels thereof.

The variables of the experiments may include, but are not limited to:
Different pressure levels, including but not limited to atmospheric pressure and reservoir pressure;
Vol chemical formulation/Vol oil proportion;
% concentration of the organic acid in the chemical formulation from 0.1 to 10% weight;
% concentration of the nonionic surfactant in the chemical formulation from 0.1 to 10% weight;
% concentration of the weak base in the chemical formulation from 0.1 to 10% weight;
Variations in the specific nature of the chemical formulation components;
Oil type (paraffinic, naphthenic, aromatic or mixed); and
Formation properties.
b) Measurement of at least one of the following: flow rate, composition and physical properties of the exiting mixture; measurement of visual and electrical signals; MRI images of the core sample; or acoustic imaging or direct macroscopic or microscopic visualization, with or without the use of a camera; weighing the core sample or the fluids; measurement of fluid levels on a graded container, and use of the Amott Method methodology and metering; measurements of capillary number associated to the USBM method.
c) Measurements of the above-mentioned variables after pressure has been applied or ceased, such as the post flooding drained core sample measurement inside or outside the container.
d) Building the “Knowledge Database” with the experimental results to feed a multidimensional model to estimate a wettability index and permeability recovery obtained with the set of parameters described in (a), (b) and (c). The database may be stored in electronic or digital media for computational processing.

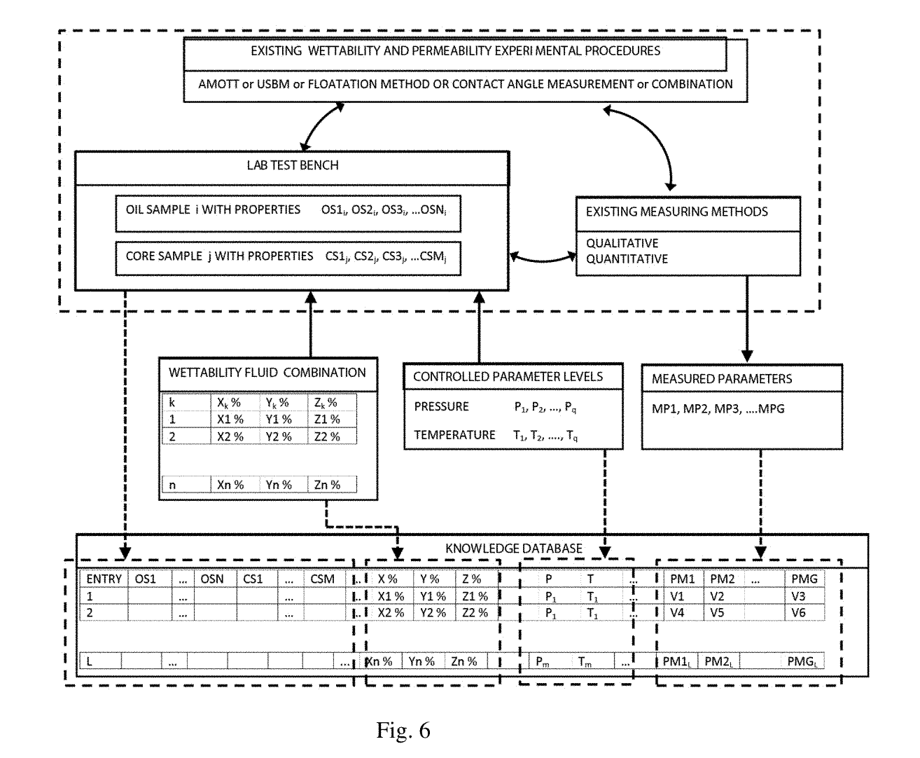

FIG. 6 is a schematic drawing of the process to obtain the data on the Knowledge Database. A Test Bench with the capability of allocating a core sample “j” with presence of an oil sample “i” is used to perform laboratory tests in which a solution of the chemical formulation of the wettability modifier fluid with an specific concentration and proportion of its components defined by Xₖ%, Yₖ% and Zₖ% following any of the known wettability measurement experimental procedures like Amott, USBM, Floatation Method, Contact Angle Measurement, or combinations of them at controlled pressure “P” and temperature “T” levels, up to a number of “q” levels. The performance of the supplied chemical formulation on that couple of oil “i” and core “j” samples is measured by parameters called MP₁, MP₂, up to a number of “G” chemical or physical parameters, like core wettability index, wettability change rate, absolute permeability, permeability change, permeability recovery, relative permeability, visual presence of residues on core sample surface or any other surface, and oil absolute flow rate, flow rate variation, draining time, visual homogeneity by known qualitative and quantitative laboratory measuring devices and procedures. For each combination of an oil sample “i” and a core sample “j” the procedure is repeated varying the concentration and proportion of the components of the wettability modification chemical formulation up to a number of “k” levels, with variation of “q” pressure and temperature levels. The oil and core samples index number “i” and “j” can be from a single unit up to an undetermined number, as it is desired to include as much different oil and formation cores as possible to broaden applicability of the product. The “i” and “j” oil and core samples are linked to the obtained results in the knowledge database by their corresponding physical and chemical properties, known from laboratory characterization measurements, which properties are named “OS 1” up to a number of “OS N” representing “N” properties for the oil sample, and “CS 1” up to a number to “M” properties for the core sample. One exemplary embodiment of the Knowledge Database is a two dimensional matrix with one of the dimension equal to the number of experiments “L”, resulting from combining the total number of the oil and core samples tested, the combination of “k” levels of each of the selected components of the chemical formulation and the “q” levels of the controlled pressure and temperature, with “L” equal to the number of experiments obtained as a result of an statistical design of experiments involving all the mentioned variables with its levels.

### “Processing Subsystem”

a) An information system to analyze the historical and experimental data from the “Knowledge Database” in order to identify trends and correlation between parameters and chemical components and concentrations, establishing performance index curves, which in some embodiments is a computational software.
b) An interpolation tool by multivariate analysis or any other tool to generate or identify the best proportions of the components in the chemical formulation, associated to a set of well and oil parameters.
c) Processing resources, centralized in a single processing unit, or split in modules with the capability of remote communication among different devices and interfaces

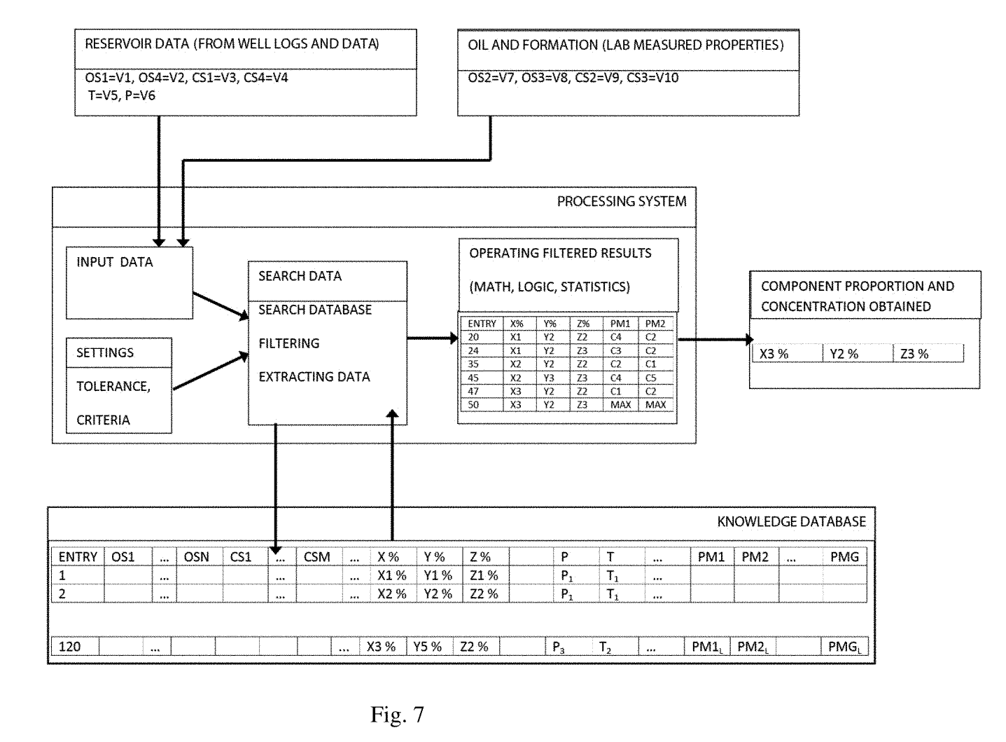

FIG. 7 is a schematic drawing of the method to determine the best proportion and concentration of the components of a chemical formulation for stimulation of medium, heavy and extra-heavy oil wells through wettability modification of well hydrocarbon bearing formations. The data from the oil well to be stimulated can be obtained from well logs and laboratory measurements, and refers to the chemical and physical properties of the reservoir formation and fluids, the well conditions such as pressure and temperature of the reservoir and depth of the producing sands. The reservoir data illustrated in FIG. 7 is represented for exemplary purposes by the oil sample parameters OS1, and OS4 and the formation parameters CS1 and CS4, at pressure and temperature “P” and “T”, with their respective values V1, V2, V3, V4, V5 and V6 obtained from well logs. Additional Oil and formation properties of the well are obtained by laboratory tests, represented in FIG. 7 for OS2, OS3, SC2 and CS3 with their respective values V7, V8, V9 and V10. All the parameters with their corresponding values are considered the input data of the method. The user defines the tolerance range and the criteria of importance of the input data in order to locate the matching values of the recorded parameters in the Knowledge Database, in order to filter and extract the entries of the database corresponding to those values, with the information of composition and concentration of the chemical formula X %, Y %, and Z % and the measured performance values PM1 to PMG for each entry. The filtered entries are represented by a table with entries values in the first column for exemplary purpose of “20”, “24”, “35”, “45, “47” and “50”. The processing system compares the values according to the specified criteria, and selects the entry with the best value of the performance parameters PM1 to PMG. The processing system outputs the value of the concentration and proportion of the chemical formulation corresponding to the selected entry, which in FIG. 7 corresponds to the “Entry 50” and concentration values of “X3%”, “Y2%” and “Z3%” for exemplary purposes.

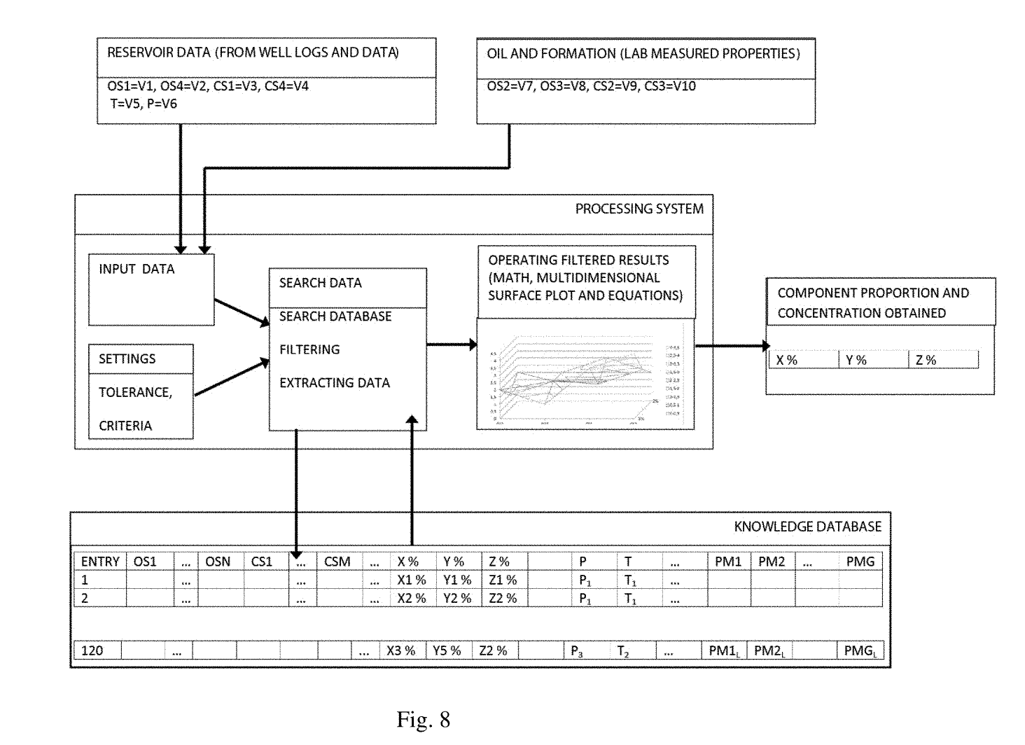

FIG. 8 is a schematic drawing of the method shown in FIG. 7 with a variation on the Processing System. The Processing System in FIG. 8 takes the input values with corresponding criteria and tolerance ranges, but instead of selecting a particular entry in the Knowledge Database matching the input data, it filters the entries according to a criteria and mathematically generates curves and multidimensional surfaces or plots with their respective regressions and equations with the database filtered entries, and then finds the optimal concentration and proportion of the chemical formulation “X %”, “Y %”, “Z %” by evaluating on those plots or on the equations describing those curves, the points where the “PM1” to “PMG” parameters are best for wettability purposes, according to the selected criteria.

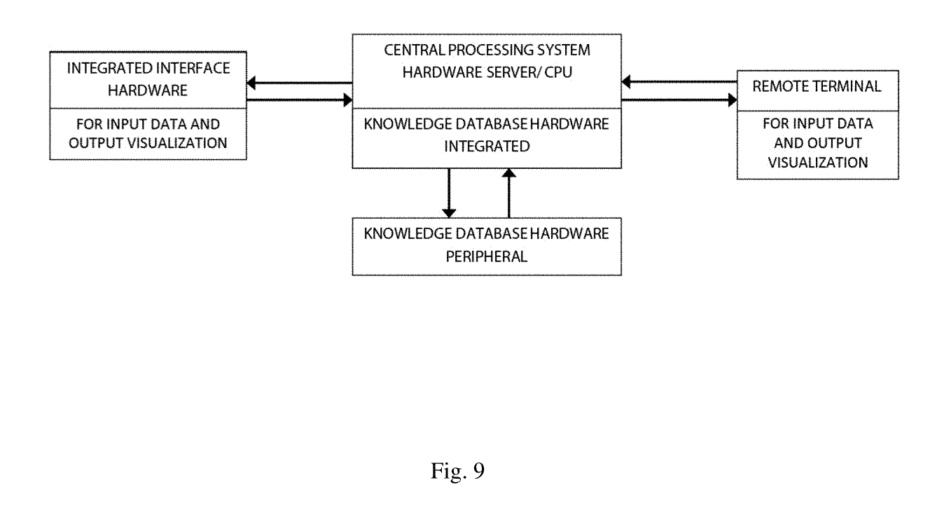

FIG. 9 is a schematic drawing of an exemplary hardware configuration for performing the exemplary methods. A central CPU/Server is connected to the Knowledge Database by either integrated devices or peripheral devices connected via a communication network. The central CPU/Server interface with the user can be either integrated interface peripherals connected to the CPU/Server device, or remote terminals connected to the central CPU/Server via any communication network, those terminals being any type of portable devices like phones, tablets, laptop devices or similar or stationary devices, such as a computer.

Once the correct proportion and concentration of the chemical formulation for a specific well is determined, the stimulation operation begins with the preparation of a diluted solution from 10 to 30% weight in water, formation water or brine. The volume of the diluted solution to be injected depends on the desirable penetration into the formation, formation permeability and porosity, reservoir residual pressure, reservoir temperature, surface ambient temperature, reservoir oil physical properties, depth of formation to be stimulated, well completion dimensions and percentage of oil/gas/water presence in reservoir. The diluted solution may be injected into the oil well by existing workover equipment with the ability of regulating the pressure and flow of such fluid. Some exemplary embodiments of the method involves the use of a coiled tubing equipment to produce the injection of the diluted fluid into the formation. As mentioned above, the theoretical injection pressure is also estimated considering the same parameters used for the calculation of the diluted fluid volume. The diluted fluid can be injected at constant pressure or following pressure ramps or by pulsating pressure, depending on the well formation and oil characteristics. After injection of the fluid, a certain dine period, from 12 to 48 h. elapses to allow the fluid to penetrate in the formation and modify the wettability of the formation, promoting crude oil flow into the well, or until a new diluted stimulation fluid injection is made. The evaluation of the well oil production determines the decision of a new cycle of injection/waiting time.

While the invention has been shown and described with reference to specific exemplary embodiments, it should be understood by those skilled in the art that several changes in form and detail may be made therein without departing from the spirit and scope of the invention as defined by the following claims.

What is claimed is:

1. A chemical formulation for stimulation of medium, heavy and extra-heavy oil wells through wettability modification of hydrocarbon bearing formations of the wells from oil-wet behavior to water-wet behavior, comprising:
a water soluble organic acid;
a non-ionic surfactant;
a weak base; and
a non-aromatic solvent dissolved in brine.

2. The chemical formulation of claim 1, wherein said water soluble organic acid acts as a surfactant precursor and has a pKa value between −2 and 2, said water soluble organic acid being selected from the group consisting of: sulfonic acids, alkylsulfonic acids, arylsulfonic acids, and mixtures thereof.

3. The chemical formulation of claim 1, wherein said non-ionic surfactant acts a co-surfactant and is selected from the group consisting of: ethoxylated fatty alcohols, ethoxylated fatty acids, ethoxylated fatty acid esters, ethoxylated phenols and/or alkylphenols, polyethylene glycol ethers, and mixtures thereof.

4. The chemical formulation of claim 1, wherein said weak base has a pKb value between 6 and 10 and is selected from the group consisting of: carboxylates, sodium acetate, sodium citrate, potassium acetate, potassium citrate, sodium bicarbonate, potassium bicarbonate, phosphonates, and mixtures thereof.

5. The chemical formulation of claim 1, wherein said weak base is a potassium salt or a sodium salt of a weak acid.

6. The chemical formulation of claim 1, wherein the weak base acts as a pH regulator for a final pH value between 4 and 7.

7. The chemical formulation of claim 1, wherein said non-aromatic solvent is a low molecular weight oxygenated compound.

8. The chemical formulation of claim 1, wherein the brine is an aqueous solution of sodium chloride or potassium chloride at a 1 to 10% weight concentration that is prepared from fresh water, formation water, any other source of water, or a mixture thereof.

9. The chemical formulation of claim 1, wherein a proportion and a concentration of the organic acid, the non-ionic surfactant, the weak base, and the non-aromatic solvent can be adjusted to achieve the best results in said well formation wettability modification from oil-wet behavior to water-wet behavior.

10. A method to determine a best proportion and concentration of components of a chemical formulation for stimulation of medium, heavy and extra-heavy oil wells through wettability modification of well hydrocarbon bearing formations, from oil-wet behavior to water-wet behavior, the chemical formulation comprising a water soluble organic acid, a non-ionic surfactant, a weak base, and a non-aromatic solvent dissolved in brine, said chemical formulation promoting a strong water-wet wettability behavior of a type of mineral reservoir bearing a type of crude oil when said chemical formulation is injected in said mineral reservoir, said method comprising:
obtaining well data with a characterization procedure;
executing a data processing subsystem;
extracting fluid behavior data stored in a knowledge database, and
obtaining a best predicted concentration and proportion of said components of said chemical formulation.

11. The method according to claim 10, wherein said well data obtained in said characterization procedure includes a crude type, a crude oil API gravity, a chemical nature of crude oil, a crude oil maturity, a geological formation of the reservoir, water/gas/oil proportions, a production water composition, a depth of producing sands, a mineralogy of formation sands, a temperature, a natural pressure, a permeability, a porosity, historic flow rates, and historical data on type of fluids used in preceding enhanced oil recovery procedures of the well.

12. The method according to claim 10, wherein the said well data is obtained from existing records including well logging, seismic logging and other registered information.

13. The method according to claim 10, wherein said well data is obtained from testing in location.

14. The method according to claim 10, wherein said well data is obtained from testing on formation core samples and oil samples coming from said well.

15. The method according to claim 10, wherein said data processing subsystem is a computational system including at least one software component and at least one hardware component.

16. The method according to claim 15, wherein said at least one software component and said at least one hardware component are remotely connected through a communication network.

17. The method according to claim 10, wherein said data processing subsystem determines the best proportion or concentration of said components of said chemical formulation through mathematical and statistical operation of said well data and said formulation behavior data extracted from said knowledge database.

18. The method according to claim 10, wherein said formulation behavior data stored in said knowledge database is qualitative data or quantitative data.

19. The method according to claim 10, wherein said formulation behavior data stored in said knowledge database is obtained by experimental procedures where physical and chemical parameters are measured by known measuring laboratory procedures when said chemical formulation with variations on the concentration or proportion of said components is applied to a core sample in presence of crude oil and formation water under controlled pressure and temperature conditions.

20. The method according to claim 19, wherein said experimental procedures include at least one of an Amott method, a USBM method, a floatation method, a relative permeability method, and a contact angle measurement.

21. The method according to claim 19, wherein said physical and chemical measured parameters include at least one of a core wettability index, a wettability change rate, an absolute permeability, a permeability change, a permeability recovery, a relative permeability, a visual presence of residues on a core sample surface or any other surface, an oil absolute flow rate, a flow rate variation, a draining time, and a visual homogeneity.

22. The method according to claim 19, wherein said core sample is one of a synthetic core and an oil well formation core with known physical and mineral properties.

23. The method according to claim 10, wherein said best predicted concentration and proportion of said components of said chemical formulation comprises a change in the proportion between said organic acid and the said non-ionic surfactant.

24. The method according to claim 10, wherein said best predicted concentration and proportion of said components of said chemical formulation consists on changing the HLB of said organic acid and said non-ionic surfactant.

25. The method according to claim 10, further comprising entering the results obtained from injecting said chemical formulation in said well with the best proportion and concentration obtained of said components into said knowledge database.

26. A method for stimulating an oil/gas well due to wettability modification of an oil bearing formation by treating the well with a chemical formulation comprising components including a water soluble organic acid, a non-ionic surfactant, a weak base, and a non-aromatic solvent dissolved in brine, said method comprising:
obtaining a best predicted concentration and proportion of said components of said chemical formulation for water-wet behavior of said formation;
preparing a diluted solution of said chemical formulation for wettability modification in water, formation water or brine to allow said formation injection and penetration;
injecting said diluted solution into the well;
waiting time to achieve optimal penetration and the physical-chemical effect of said diluted solution into said formation; and
evaluating the effect in said well oil production.

27. The method according to claim 26, wherein said water soluble organic acid is selected from the group consisting of: sulphonic acids, alkylsulphonic acids, arylsulphonic acids and mixtures thereof.

28. The method according to claim 26, wherein said non-ionic surfactant is selected from the group consisting of: ethoxylated fatty alcohols, ethoxylated fatty acids, ethoxylated fatty acid esters, ethoxylated phenols, ethoxylated alkylphenols, polyethylene glycol ethers, and mixtures thereof.

29. The method according to claim 26, wherein said weak base is selected from the group consisting of: carboxylates, carbonates, phosphonates, and mixtures thereof.

30. The method according to claim 26, wherein said weak base is a potassium salt or a sodium salt of a weak acid.

31. The method according to claim 26, wherein said non-aromatic solvent is a low molecular weight oxygenated compound.

32. The method according to claim 26, wherein said chemical formulation is in a concentration in the range between approximately from 1 to 50% weight.

33. The method according to claim 26, wherein said chemical formulation is diluted to a 10 to 30% weight proportion in water, formation water, or brine.

34. The method according to claim 26, wherein said crude oil is a heavy crude oil having an API gravity in the range of from about 12 to about 22.

35. The method according to claim 26, wherein said crude oil is an extra heavy crude oil having an API gravity in the range of from about 7 to about 12

36. The method according to claim 26, wherein the said chemical formulation also reduces friction of the produced oil in conduits of the well.

37. The method according to claim 26 further comprising the step of calculating a volume of said diluted solution to be injected.

38. The method according to claim 37, wherein said diluted solution volume depends on at least one of a desirable penetration of said diluted fluid into said formation, a formation permeability and porosity, a reservoir residual pressure, a reservoir temperature, a surface ambient temperature, reservoir oil physical properties, a depth of said formation to be stimulated, completion dimensions of said well, and a percentage of oil/gas/water present in said reservoir.

39. The method according to claim 26, further comprising adjusting a required injection pressure level of said diluted solution.

40. The method according to claim 39, wherein said pressure level depends on at least one of the desirable penetration of said diluted fluid into the formation, formation permeability and porosity, reservoir residual pressure, reservoir temperature, surface ambient temperature, reservoir oil physical properties, depth of stimulating formation, well completion dimensions, and percentage of oil/gas/water presence in reservoir.

41. The method according to claim 26, wherein said diluted solution is injected at a continuous pressure.

42. The method according to claim 26, wherein said diluted solution is injected at a pulsating pressure.

43. The method according to claim 26, further comprising additional sequential steps of injecting said diluted solution followed by a waiting time to allow said diluted solution to penetrate into said formation and allow the physical-chemical effects on the formation to take place.

44. The method according to claim 26, further comprising aiding the oil flow due to a negative downhole pressure generated by a downhole tool.
